(19) United States
(12) Patent Application Publication
(10) Pub. No.: US 2005/0206937 A1
(43) Pub. Date: Sep. 22, 2005

(54) Image forming apparatus

(75) Inventor: Kazunori Hirabayashi, Tagata-gun (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/805,303

(22) Filed: Mar. 22, 2004

(51) Int. Cl. G06F 15/00

(52) U.S. Cl. 358/1.13

(57) ABSTRACT

When it is determined that a line object is drawn by a line drawing command, a CPU compares a value of line width (input line width) of the line object with a predetermined threshold of the line width. If it is determined that the line object is a thin-line object (a line object that is likely to blur) (input line width<threshold), the CPU executes a process to change the value of line width to a proper value. When processing for one page is completed, the CPU executes a print process using a printer engine.

### BACKGROUND OF THE INVENTION

1. Field of the Invention

The present invention relates to an image forming apparatus that forms an image on the basis of PDL information.

2. Description of the Related Art

In a conventional image forming apparatus, when a line object is to be drawn, a PDL (Printer Description Language: PostScript, PCL_XL, etc.) file is first prepared using a printer driver or the like in a personal computer, etc. The line object is drawn according to a line drawing command contained in the description in the PDL file. In addition, a line object may be drawn using a polygon object.

There is known a process of preventing blurring, etc. of a line object. In this process, in a device driver or the like, a line object, which is likely to blur, is extracted from PDL line drawing commands and image data, and the values of the attributes of the extracted line object are changed.

However, when a line object is to be drawn on the basis of a line drawing command or a polygon object, there are cases where a line cannot be drawn by a printer. For example, a line on print matter blurs due to line width, color, etc. Thus, there is problem that a line object cannot exactly be drawn.

In any of prior-art methods, a change is added to PDL by a device driver, etc. It has not been thought, however, to make a change on low-level drawing commands (display list).

### BRIEF SUMMARY OF THE INVENTION

The object of an aspect of the present invention is to provide an image forming apparatus and a program for an image forming apparatus, which realize exact drawing of a line object when the line object is to be drawn on the basis of a line drawing command or a polygon object.

According to an aspect of the present invention, there is provided an image forming apparatus that forms an image on the basis of PDL information, comprising: determination means for determining whether the PDL information is a line object that is drawn by a line drawing command; comparison means for comparing, if the determination means determines that the PDL information is a line object that is drawn by a line drawing command, a value of line width of the line object with a threshold of the line width; changing means for changing, if a comparison result of the comparison means shows that the value of line width of the line object is less than the threshold, the line width of the line object; and drawing means for drawing the line object with the line width that is changed by the changing means.

According to another aspect of the present invention, there is provided a program for causing an image forming apparatus, which forms an image on the basis of PDL information, to execute a process, comprising: determining whether the PDL information is a line object that is drawn by a line drawing command; comparing, if it is determined that the PDL information is a line object that is drawn by a line drawing command, a value of line width of the line object with a threshold of the line width; changing, if a comparison result shows that the value of line width of the line object is less than the threshold, the line width of the line object; and drawing the line object with the changed line width.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of an aspect of the invention.

FIG. 1 is a block diagram that schematically shows the structure of an image forming system according to the present invention;

FIG. 2 is a flow chart illustrating a process operation of a printer controller;

FIG. 3 shows examples of modes of line objects;

FIG. 4 shows an example of a mode of a thin-line object;

FIG. 5 shows an example of a mode of a thin-line object;

FIG. 6 shows an example of a mode of a thin-line object relative to a screen;

FIG. 7 is a flow chart illustrating another process operation; and

FIG. 8 is a flow chart illustrating another process operation.

### DETAILED DESCRIPTION OF THE INVENTION

Embodiments of the present invention will now be described with reference to the accompanying drawings.

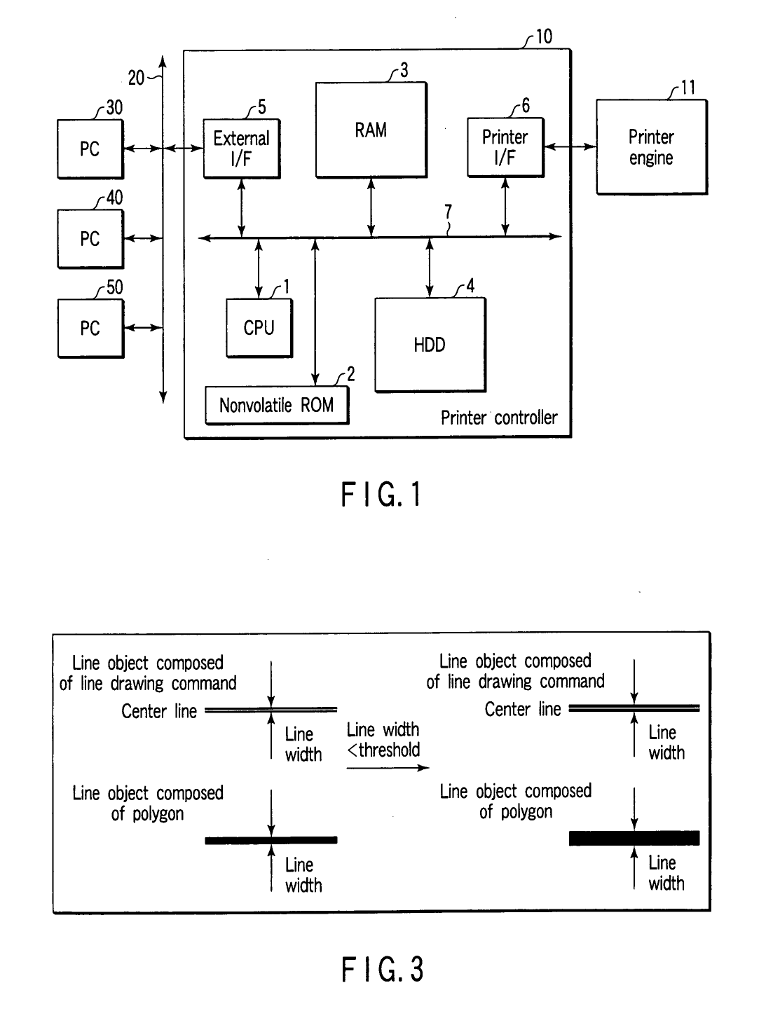

FIG. 1 schematically shows the structure of an image forming system according to the present invention.

A printer controller 10 is connected to a printer engine (drawing means) 11.

The printer controller 10 is also connected to personal computers (PC) 30, 40 and 50 over a network 20.

Processing in this invention is executed as a program in the printer controller 10.

The printer controller 10 includes a CPU 1 that controls the entirety of the system, a rewritable nonvolatile ROM 2 that stores a program, etc., a RAM 3 that temporarily stores data, a hard disk drive (HDD) 4 that is used to store data, etc., an external interface (I/F) 5 for connection to the network 20, and a printer interface (I/F) 6 for connection to the printer engine 11. The CPU 1, nonvolatile ROM 2, RAM 3, HDD 4, external I/F 5 and printer I/F 6 are communicable over a communication bus 7.

In addition, the printer controller 10 is communicable via the external I/F 5 with the PCs 30, 40 and 50 that are connected to the network (transmission medium) 20. The printer controller 10 is communicable with the printer engine 11 via the printer I/F 6.

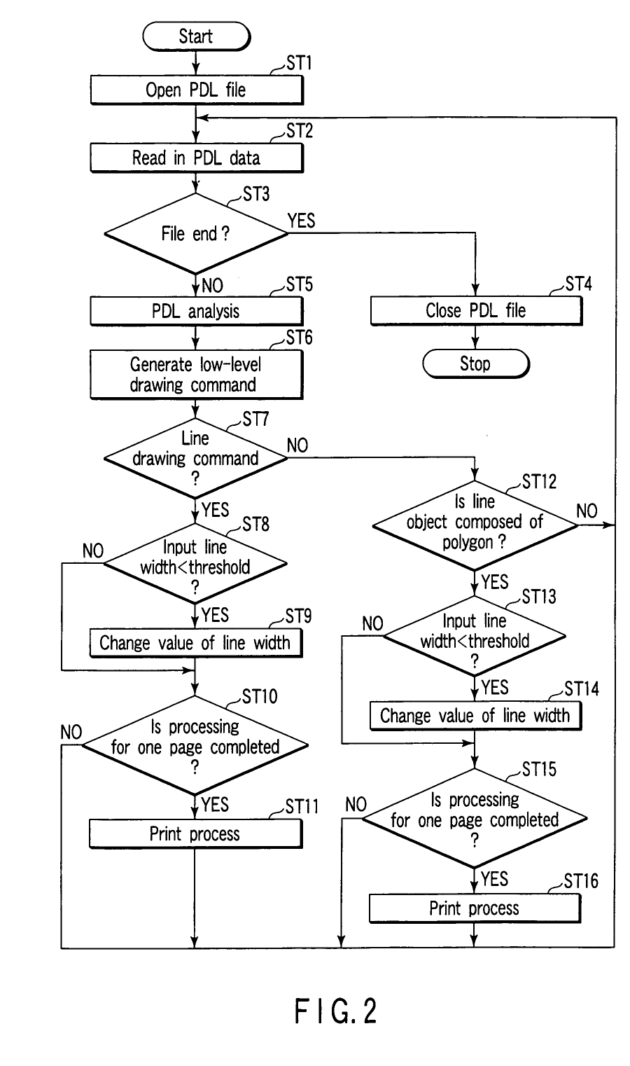

Next, the process operation of the printer controller 10 with the above-described structure is described referring to a flow chart of FIG. 2.

To begin with, the PC 30, for instance, uses a printer driver to generate a PDL (PostScript 3, PCL_XL, etc.) file. The PDL file is delivered to the printer controller 10 via the network 20. The PDL file is temporarily stored as a file in the RAM 3 or HDD 4. Assume that the PDL file is stored in the HDD 4.

The CPU 1 in the printer controller 10 functions as a RIP (Raster Image Processor) to open the PDL file in the HDD 4 (ST1) and reads in the PDL file (PDL information) (ST2).

The CPU 1 determines whether there is a file end (ST3). If there is a file end, the CPU 1 closes the PDL file in the HDD 4 and finishes the process (ST4).

If there is no file end in step ST3, the CPU 1 analyzes the PDL file (ST5) and generates a low-level drawing command (display list) (ST6).

Then, the CPU 1 determines whether a line object, which is to be drawn by the generated low-level drawing command, is drawn by the line drawing command or a line object that is composed of a polygon (ST7).

If it is determined in step ST7 that the line object is drawn by the line drawing command, the CPU 1 executes determination by comparing the value of line width (input line width) of the line object and a predetermined threshold of line width (ST8).

If the input line width<the threshold in step ST8, that is, if it is determined that the line object is a thin-line object (a line object that is likely to blur), the CPU 1 executes a process to change the value of line width to a proper value (ST9). If the input line width≧the threshold, control goes to step ST10.

If NO in step ST8, or after the processing in step ST9, the CPU 1 checks whether processing for one page is completed (ST10).

If the processing for one page is completed in step ST10, the CPU 1 executes a print process using the printer engine 11 (ST11) and returns to step ST2.

If the processing for one page is not completed in step ST10, the CPU 1 returns to step ST2.

If it is determined in step ST7 that the line object is not drawn by the line drawing command, the CPU 1 checks whether the line object is composed of a polygon (ST12). If the line object is not composed of a polygon, control returns to step ST2.

If the line object is composed of a polygon in step ST12, the CPU 1 executes determination by comparing the value of line width (input line width) of the line object and a predetermined threshold of line width (ST13).

If the input line width<the threshold in step ST13, that is, if it is determined that the line object is a thin-line object (a line object that is likely to blur), the CPU 1 executes a process to change the value of line width to a proper value (ST14). If the input line width≧the threshold, control goes to step ST15.

If NO in step ST13, or after the processing in step ST14, the CPU 1 checks whether processing for one page is completed (ST15).

If the processing for one page is completed in step ST15, the CPU 1 executes a print process using the printer engine 11 (ST16) and returns to step ST2.

If the processing for one page is not completed in step ST15, the CPU 1 returns to step ST2.

As a result, when a print output is produced from the printer engine 11, blurring of a thin-line drawing part can be avoided, and a better print image is obtained.

Since the threshold is variable, the similar process can be performed on a line object with such a line width as not to blur in normal cases.

FIG. 3 shows an example of the above-described mode. As is shown in FIG. 3, in the case of the line drawing command, the width is determined on the basis of a center line, and thus a line object is drawn. On the other hand, a line, which is drawn by a polygon in this example, is drawn as a right-angled tetragon or a set of continuous right-angled tetragons. In this case, if the line width is less than a threshold (freely selectable), the value of line width is changed to a proper one.

In the process illustrated in FIG. 2, different advantageous effects can be obtained if the processing for determining the line object that is likely to blur is replaced with the processing for executing determination by comparing the threshold relating to the attributes (width, angle, line type, hue, saturation, brightness, etc.) of image information of the line object or the threshold of the angle of a screen pattern with the attributes of the line object.

In addition, if the attribute of the line object and the threshold are determined after the processing for determining the line object that is likely to blur, and the determination result is combined in the processing, further advantages can be obtained.

By finally changing the value of the attribute of image formation, blurring of the line object due to factors other than line width can be prevented, and the appearance of the line object can be improved.

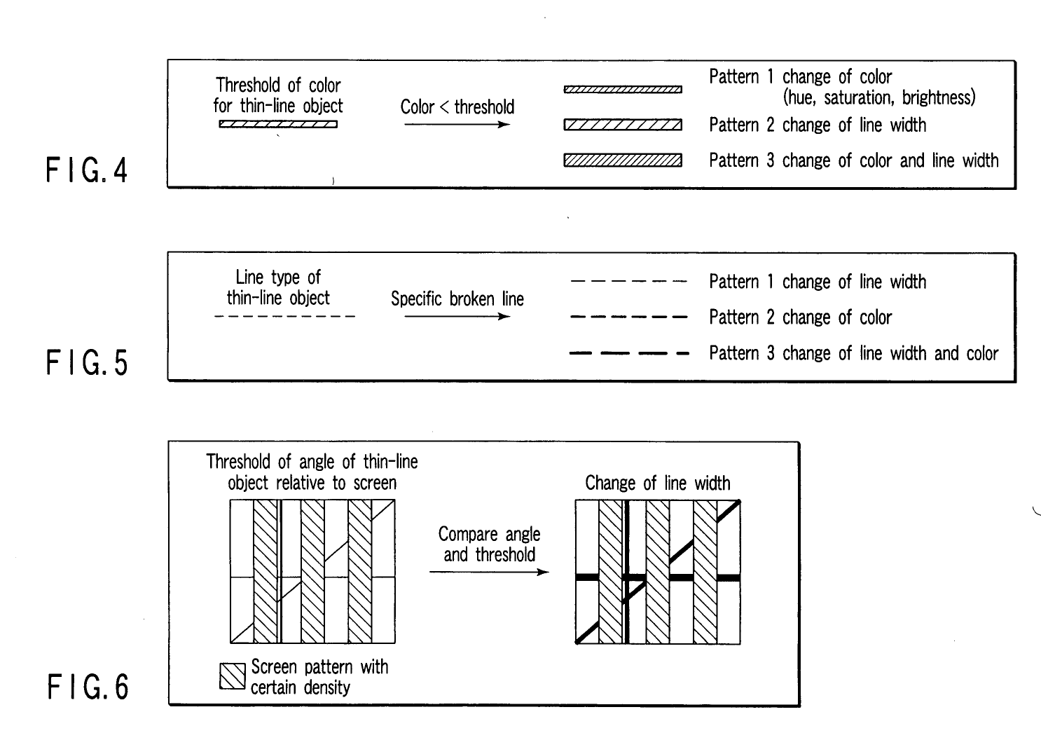

FIG. 4 shows an example of the mode of the line (thin line) object due to processing for respective attributes. That is, FIG. 4 illustrates an example of the processing using a result of comparison between the threshold of color (expressed by attributes such as hue, saturation, brightness, etc.) and the color of the line object. FIG. 4 shows modes of “change of color”, “change of line width” and “change of color and line width” of the line object. For example, if the threshold of color is set at yellow 50% and the color of the thin-line object is yellow 30%, the percentage of yellow is raised to yellow 50%. Thereby, a line with more sharpness can be drawn.

FIG. 5 shows an example of the mode of the line (thin line) object due to processing for line type (broken line). Depending on the kind of line, such modes as “change of line width”, “change of color” and “change of line width and color” are shown. The broken line is given as an attribute of a line drawing command, or is expressed by, e.g. a combination of polygons. If the drawn line object is a broken line, there is a possibility that the line object “blurs” or is difficult to perceive due to its shape. For such a line object, the line width or color is changed, thereby to alleviate the problem of “blurring” or difficulty in perception.

FIG. 6 shows an example of a mode in which the angle of a line (thin line) object and the threshold of the angle, which is set by giving consideration to a screen pattern, are compared, and the line width is changed based on the result of comparison. In fact, an overlapping part with the screen pattern is displayed. In a case where the screen pattern crosses the line object at 90°, the possibility of blurring is minimum. Since some part of the original line image is subtracted by the screen, the actual line object becomes a different one. That is, further blurring may occur. This adverse effect varies depending on the angle at which the line object crosses the screen pattern. Hence, the adverse effect due to the screen pattern can be suppressed if the angle, which is set by considering the screen pattern, is used as the threshold.

It is determined whether the line object is a color one or a monochromatic one. Based on the determination result, the line width or color is changed, or the line width and color are changed at the same time. Since colors comprise four colors (C: cyan, M: magenta, Y: yellow, and K: black), misregistration occurs at the time of printing and the line width tends to increase.

In addition, in the case of a single color (C, M or Y) and a monochromatic color (K), single-color print is effected and so the line width does not increase. Taking this into account, the values of “line width”, “color” and “line width and color” are altered, thereby improving the appearance of the line object.

Next, other examples of processing will be described as variations.

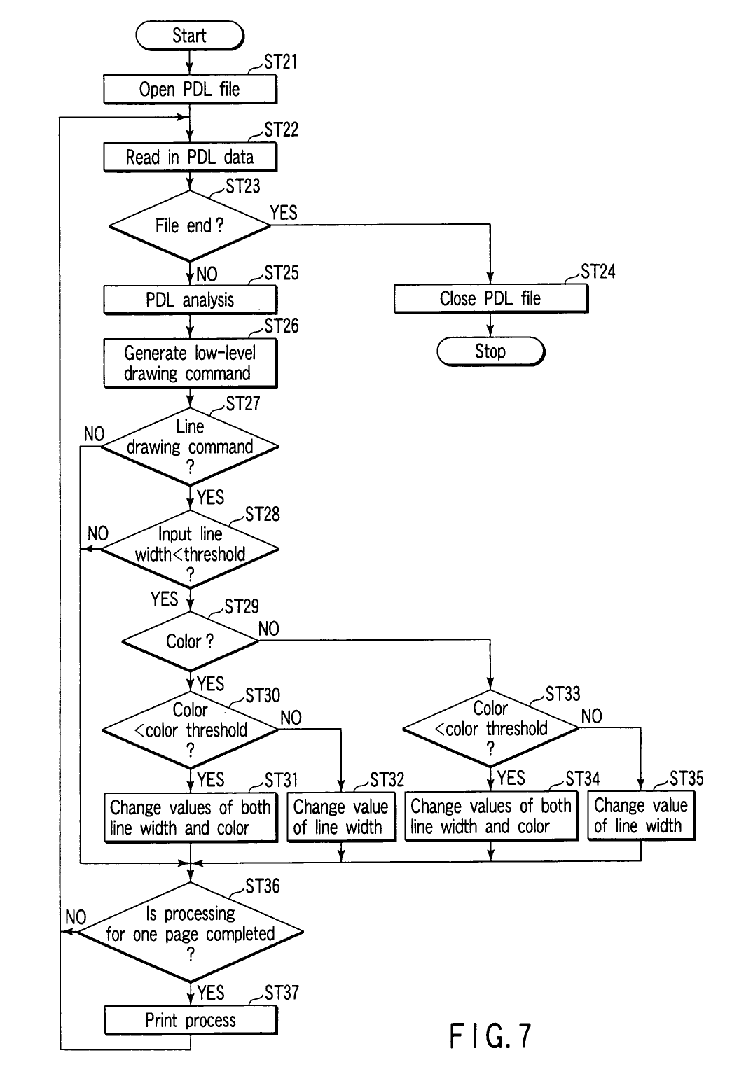

A first example of other processing is described referring to a flow chart of FIG. 7. Steps ST21 to ST26 are the same as steps ST1 to ST6, so a description is omitted here.

The CPU 1 determines, by comparison, whether a line object is drawn according to the line drawing command (ST27). If the line object is not drawn by the line drawing command, the CPU 1 goes to step ST36.

If the line object is drawn by the line drawing command, the CPU 1 compares the input line width and the line width threshold, thereby determining whether the line object is likely to blur (ST28). If the line object is not likely to blur, that is, if the input line width≧the line width threshold, the CPU 1 goes to step ST36.

If it is determined in step ST28 that the line object is likely to blur (the input line width<the line width threshold), the CPU 1 determines whether the line object is a color one or a monochromatic one (ST29).

If the line object is a color one in step ST29, the CPU 1 executes determination by comparing the color (hue, saturation, brightness) with the threshold (variable) (ST30).

If the color<the color threshold in step ST30, the CPU 1 changes the values of both the line width and color (ST31). If the color≧the color threshold, the CPU 1 changes the value of the line width to a proper value (ST32). In this case, the change of the line width, the change of the color and the change of both the line width and color are freely selectable.

If the line object is a monochromatic one in step ST29, the CPU 1 executes determination by comparing the color (hue, saturation, brightness) with the threshold (variable) (ST33).

If the color<the color threshold in step ST33, the CPU 1 changes the values of both the line width and color (ST34). If the color≧the color threshold, the CPU 1 changes the value of the line width to a proper value (ST35). In this case, the change of the line width, the change of the color and the change of both the line width and color are freely selectable.

If the value of saturation is changed, it is possible to make more easily perceptible such a difficult-to-perceive line as is drawn in thin color, e.g. yellow.

The change of the values of color is not limited to the above modes.

If the line object is not drawn according to the line drawing command in step ST27, or if it is not determined in step ST28 that the input line width<the line width threshold, or after any of steps ST31, ST32, ST34 and ST35, the CPU 1 checks whether the processing for one page is completed or not (ST36).

If the processing for one page is completed in step ST36, the CPU 1 executes a print process using the printer engine 11 (ST37) and returns to step ST22.

If the processing for one page is not completed in step ST36, the CPU 1 returns to step ST22.

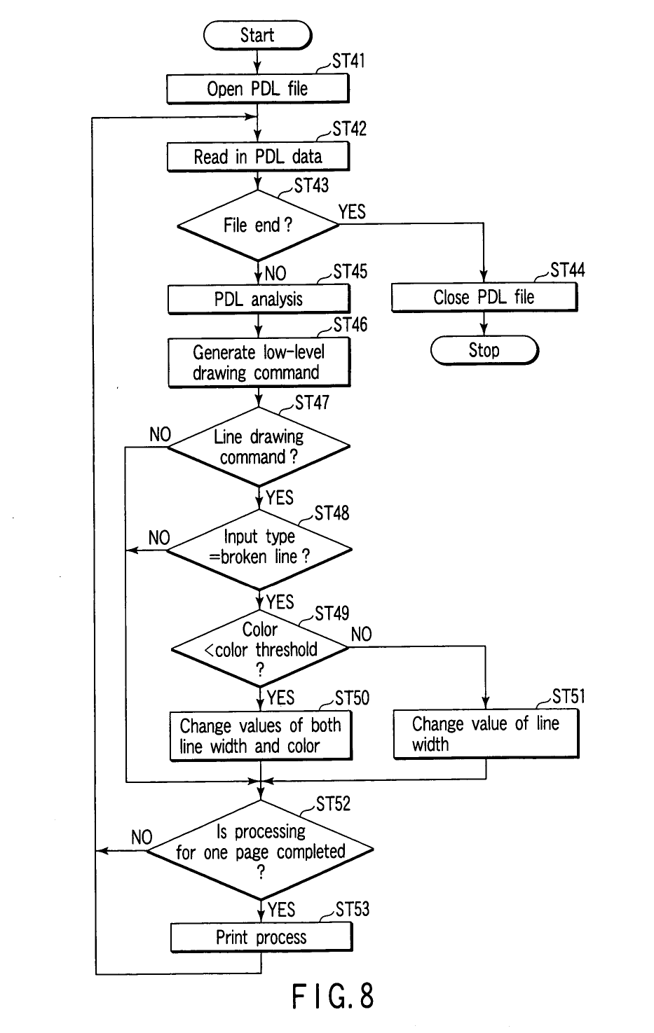

Next, a second example of other processing is described referring to a flow chart of FIG. 8. Steps ST41 to ST46 are the same as steps ST1 to ST6, so a description is omitted here.

The CPU 1 determines whether a line object, which is to be drawn by the generated low-level drawing command, is drawn according to the line drawing command (ST47). If the line object is not drawn by the line drawing command, the CPU 1 goes to step ST52.

If the line object is to be drawn by the line drawing command in step ST47, the CPU 1 determines the line type of the line object (ST48). If the line type is not a broken line in step ST48, the CPU 1 goes to step ST52.

If the line type is a broken line in step ST48, the CPU 1 executes determination by comparing the color (hue, saturation, brightness) with the threshold (variable) (ST49).

If the color<the color threshold in step ST49, the CPU 1 changes the values of both the line width and color (ST50). If the color≧the color threshold, the CPU 1 changes the value of the line width to a proper value (ST51). In this case, the change of the line width, the change of the color and the change of both the line width and color are freely selectable.

If the line object is not drawn according to the line drawing command in step ST47, or if the line type is not a broken line in step ST48, or after either step ST50 or step ST51, the CPU 1 checks whether the processing for one page is completed or not (ST52).

If the processing for one page is completed in step ST52, the CPU 1 executes a print process using the printer engine 11 (ST53) and returns to step ST42.

If the processing for one page is not completed in step ST52, the CPU 1 returns to step ST42.

As has been described above, the processing according to the embodiments of the present invention are executed on the low-level line drawing commands. Therefore, this invention is applicable to objects other than line objects expressed by PDL. For example, this invention is applicable to a case where an outline of a character is composed by a low-level line drawing command. The width of the outline of the drawn character can be changed, and the character can be made thicker.

The processing in this invention is executable irrespective of the kind of PDL (PostScript, PCL, etc.), and printer engines with different characteristics can be supported.

Thresholds are provided for attributes (width, angle, line type, hue, saturation, brightness) of image information of a line object that is composed by a line drawing command or a polygon. Determination is made in combination with a comparison result between a given attribute and a threshold. Based on the determination result, the value of the attribute of the image information is changed, thereby preventing blurring of a line, which would occur when a line object is drawn by a printer.

Although the fidelity to the original line object decreases, the appearance of the line object is improved and the quality of the output line object is enhanced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image forming apparatus that forms an image on the basis of PDL information, comprising:
determination means for determining whether the PDL information is a line object that is drawn by a line drawing command;
comparison means for comparing, if the determination means determines that the PDL information is a line object that is drawn by a line drawing command, a value of line width of the line object with a threshold of the line width;
changing means for changing, if a comparison result of the comparison means shows that the value of line width of the line object is less than the threshold, the line width of the line object; and
drawing means for drawing the line object with the line width that is changed by the changing means.

2. The image forming apparatus according to claim 1, wherein the determination means determines whether the PDL information is composed of a polygon.

3. The image forming apparatus according to claim 1 or 2, wherein the comparison means compares, if the determination means determines that the PDL information is composed of a polygon, a value of line width of the line object, which is composed of the polygon, with a threshold of the line width.

4. The image forming apparatus according to claim 1, wherein the comparison means executes a comparison with a threshold that can determine whether the line object is likely to blur when the line object is drawn.

5. The image forming apparatus according to claim 1, further comprising:
second comparison means for comparing a value of an attribute of the line object with a threshold of the attribute;
second changing means for changing the value of the attribute of the line object in accordance with a comparison result of the second comparison means; and
second drawing means for drawing the line object on the basis of the value of the attribute of the line object, which is changed by the second changing means.

6. The image forming apparatus according to claim 5, wherein the attribute of the line object is a width, an angle, a line type, hue, saturation, or brightness.

7. The image forming apparatus according to claim 5, wherein the second changing means executes change of color of the line object, change of line width of the line object, or change of both the color and line width of the line object.

8. The image forming apparatus according to claim 1, further comprising:
extraction means for extracting an angle of a screen pattern;
means for determining whether the line object is likely to blur, by comparing a value of an angle of the line object with a threshold for the line object, which is determined in consideration of the angle of the screen pattern that is extracted by the extraction means; and
means for changing the line width of the line object in accordance with a determination result of the determining means.

9. The image forming apparatus according to claim 1, further comprising:
detection means for detecting a kind of the line object; and
means for changing the color of the line object, or the line width of the line object, or the color and line width of the line object, on the basis of a detection result of the detection means.

10. The image forming apparatus according to claim 1, further comprising:
means for determining whether the line object is a color one or a monochromatic one;
means for determining whether the line object is likely to blur, on the basis of a determination result of the determining means; and
means for changing the line width of the line object, or the color of the line object, or the line width and color of the line object, if the determining means determines that the line object is likely to blur.

11. A program for causing an image forming apparatus, which forms an image on the basis of PDL information, to execute a process, comprising:
determining whether the PDL information is a line object that is drawn by a line drawing command;
comparing, if it is determined that the PDL information is a line object that is drawn by a line drawing command, a value of line width of the line object with a threshold of the line width;
changing, if a comparison result shows that the value of line width of the line object is less than the threshold, the line width of the line object; and
drawing the line object with the changed line width.

12. A program for causing an image forming apparatus, which forms an image on the basis of PDL information, to execute a process, comprising:
determining whether the PDL information is composed of a polygon;
comparing, if it is determined that the PDL information is composed of a polygon, a value of line width of the line object, which is composed of the polygon, with a threshold of the line width;
changing, if a comparison result shows that the value of line width of the line object is less than the threshold, the line width of the line object; and
drawing the line object with the changed line width.
